(19) United States
(12) Patent Application Publication
(10) Pub. No.: US 2015/0167466 A1
(43) Pub. Date: Jun. 18, 2015

(54) TACHOMETER FOR DOWNHOLE DRILLING MOTOR

(71) Applicant: WEATHERFORD/LAMB, INC., Houston, TX (US)

(72) Inventors: Sorin Gabriel Teodorescu, The Woodlands, TX (US); Scott D. Birse, Houston, TX (US); Albert C. Odell, II, Kingwood, TX (US)

(21) Appl. No.: 14/405,561

(22) PCT Filed: Jun. 7, 2013
(86) PCT No.: PCT/US2013/044665

§ 371 Date: Dec. 4, 2014

Related U.S. Application Data
(60) Provisional application No. 61/656,751, filed on Jun. 7, 2012.

(51) Int. Cl. F01C 20/28; G01M 15/14; E21B 47/01; G01P 3/44; E21B 4/02; E21B 7/00

(52) U.S. Cl. CPC F01C 20/28; E21B 4/02; E21B 7/00; E21B 47/01; G01P 3/44; G01M 15/14

(57) ABSTRACT

A tachometer for a downhole motor includes: a tubular housing having a coupling for connection to a housing of the motor; and a probe. The probe: has a coupling for connection to a rotor of the motor, is movable relative to the tachometer housing, and has at least a portion disposed in a bore of the tachometer housing. The tachometer further includes electronics disposed in the tachometer housing and including: a battery; one or more proximity sensors for tracking an orbit of the probe; and a programmable logic controller (PLC). The PLC is operable: to receive the tracked orbit, and at least one of: to determine an angular speed of the probe using the tracked orbit, and to forecast a remaining lifespan of the motor using the tracked orbit.

### CROSS-REFERENCE TO RELATED APPLICATIONS

This application claims benefit of U.S. provisional patent application Ser. No. 61/656,751, filed Jun. 7, 2013, which is herein incorporated by reference.

### BACKGROUND OF THE DISCLOSURE

1. Field of the Disclosure

Embodiments of the present disclosure generally relate to tachometer for a downhole drilling motor.

2. Description of the Related Art

In wellbore construction and completion operations, a wellbore is formed to access hydrocarbon-bearing formations (e.g., crude oil and/or natural gas) by the use of drilling. Drilling is accomplished by rotating a drill bit that is mounted on the end of a drill string. The drill bit is often rotated by a top drive or rotary table on a surface platform or rig, and/or by a downhole motor mounted towards the lower end of the drill string. After drilling to a predetermined depth, the drill string and drill bit are removed and a section of casing is lowered into the wellbore. An annulus is thus formed between the string of casing and the formation. The casing string is temporarily hung from a wellhead of the well. A cementing operation is then conducted in order to fill the annulus with cement. The casing string is cemented into the wellbore by circulating cement into the annulus defined between the outer wall of the casing and the borehole. The combination of cement and casing strengthens the wellbore and facilitates the isolation of certain areas of the formation behind the casing for the production of hydrocarbons.

From time to time, conditions may arise which mitigate the effectiveness of the downhole motor and may even damage the motor. For example, the motor may stall during operation. A motor may stall for a number of reasons, such as setting down too much weight-on-bit, running the bit into a tight area and pinching the bit-box, or a stator failure. It is both expensive and time-consuming to pull the motor out of the wellbore each time there is doubt as to whether the motor is turning.

Conventionally, the relevant operating parameters which are observed during operation of a motor during drilling include pressure and flow. These parameters may be used individually or collectively to characterize the operation of the motor. For example, in the event of a motor stall, blockage or restriction, the pressure drop in the motor is expected to increase above the operating pressure.

Angular velocity and torque of a positive displacement motor are computed using information on flow rate and pressure drop. Such a computation is facilitated by characteristic curves contained in performance charts provided by manufacturers of downhole motors. However, such approaches are not always accurate. For example, depending on the particular problem, the pressure may not exhibit any change, regardless of the condition of the motor.

Another technique for monitoring and characterizing the operation of a motor downhole is by acoustics. For example, one approach is to determine drill bit speed by isolating the rotor whirl frequency of a progressive cavity motor. However, this technique is limited because some motors do not create a strong acoustical signature all the time. Often, it is not possible to acoustically differentiate a stalled motor from a rotating motor.

### SUMMARY OF THE DISCLOSURE

Embodiments of the present disclosure generally relate to tachometer for a downhole drilling motor. In one embodiment, a tachometer for a downhole motor includes: a tubular housing having a coupling for connection to a housing of the motor; and a probe. The probe: has a coupling for connection to a rotor of the motor, is movable relative to the tachometer housing, and has at least a portion disposed in a bore of the tachometer housing. The tachometer further includes electronics disposed in the tachometer housing and including: a battery; one or more proximity sensors for tracking an orbit of the probe; and a programmable logic controller (PLC). The PLC is operable: to receive the tracked orbit, and at least one of: to determine an angular speed of the probe using the tracked orbit, and to forecast a remaining lifespan of the motor using the tracked orbit.

In another embodiment, a method of drilling a wellbore of includes drilling the wellbore by injecting drilling fluid through a drill string extending into the wellbore from a drilling rig and rotating a drill bit disposed on a bottom of the drill string. The drill string includes a downhole drilling motor and the motor rotates the drill bit. The method further includes while drilling the wellbore and in real time: tracking an orbit of a rotor of the motor; and at least one of: determining an angular speed of the rotor using the tracked orbit, and forecasting a remaining lifespan of the motor using the tracked orbit.

In another embodiment, a method of drilling a wellbore of includes drilling the wellbore by injecting drilling fluid through an annulus formed between the wellbore and a drill string extending into the wellbore from a drilling rig and rotating a drill bit disposed on a bottom of the drill string. The drill string includes a downhole drilling motor and the motor rotates the drill bit. The method further includes while drilling the wellbore and in real time: tracking an orbit of a rotor of the motor; and at least one of: determining an angular speed of the rotor using the tracked orbit, and forecasting a remaining lifespan of the motor using the tracked orbit.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1A and 1B illustrate an offshore drilling system, according to one embodiment of the present disclosure.

FIGS. 2A-2E illustrate a bottomhole assembly (BHA) of the drilling system. FIG. 2F illustrates an alternative power section of a drilling motor of the BHA, according to another embodiment of the present disclosure.

FIGS. 3A and 3B illustrate a tachometer of the drilling motor. FIGS. 3C and 3D illustrate an alternative tachometer for use with the drilling motor, according to another embodiment of the present disclosure.

FIGS. 4A-4F illustrate operation of the alternative tachometer.

FIG. 5A illustrates another alternative tachometer for use with the drilling motor, according to another embodiment of the present disclosure. FIG. 5B illustrates a portion of an alternative motor for use with the BHA, according to another embodiment of the present disclosure. FIG. 5C illustrates an alternative BHA, according to another embodiment of the present disclosure.

FIG. 6A illustrates operation of the alternative BHA, according to another embodiment of the present disclosure. FIG. 6B illustrates additional operation of the alternative BHA, according to another embodiment of the present disclosure.

FIG. 7 illustrates a directional BHA, according to another embodiment of the present disclosure.

FIGS. 8A and 8B illustrate an offshore drilling system in a reverse circulation mode, according to another embodiment of the present disclosure.

### DETAILED DESCRIPTION

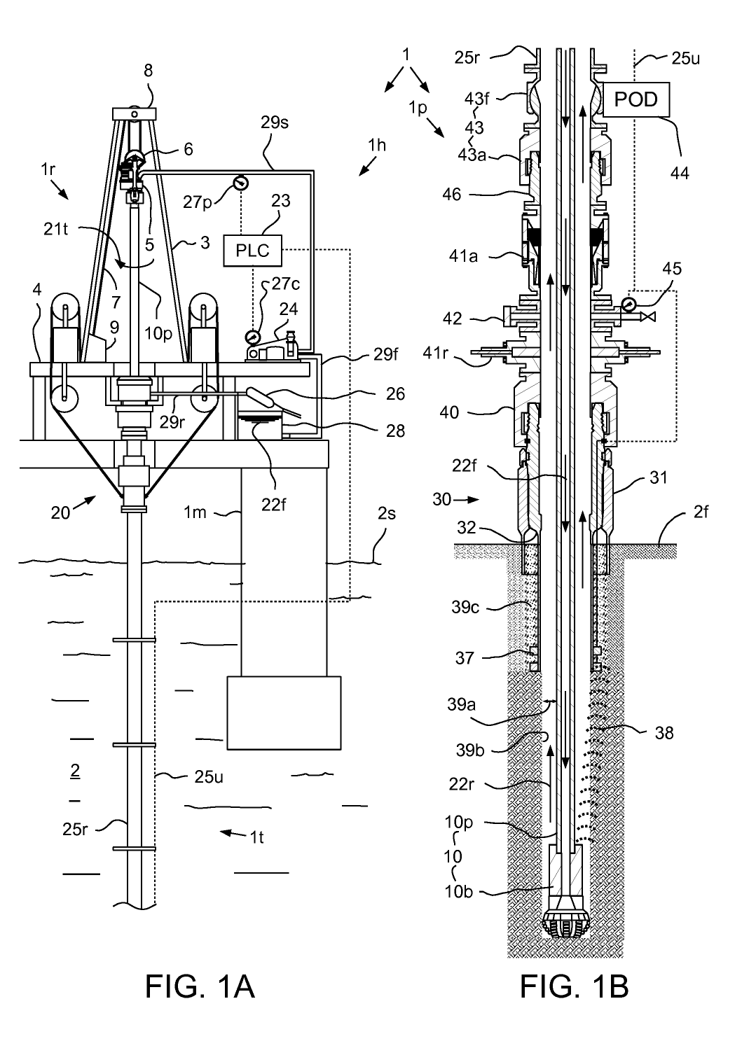

FIGS. 1A and 1B illustrate an offshore drilling system 1, according to one embodiment of the present disclosure. The drilling system 1 may include a mobile offshore drilling unit (MODU) 1m, such as a semi-submersible, a drilling rig 1r, a fluid handling system 1h, a fluid transport system 1t, a pressure control assembly (PCA) 1p, and a drill string 10. The MODU 1m may carry the drilling rig 1r and the fluid handling system 1h aboard and may include a moon pool, through which drilling operations are conducted. The semi-submersible may include a lower barge hull which floats below a surface (aka waterline) 2s of sea 2 and is, therefore, less subject to surface wave action. Stability columns (only one shown) may be mounted on the lower barge hull for supporting an upper hull above the waterline 2s. The upper hull may have one or more decks for carrying the drilling rig 1r and fluid handling system 1h. The MODU 1m may further have a dynamic positioning system (DPS) (not shown) or be moored for maintaining the moon pool in position over a subsea wellhead 50.

Alternatively, the MODU may be a drill ship. Alternatively, a fixed offshore drilling unit or a non-mobile floating offshore drilling unit may be used instead of the MODU. Alternatively, the wellbore may be subsea having a wellhead located adjacent to the waterline and the drilling rig may be a located on a platform adjacent the wellhead. Alternatively, the wellbore may be subterranean and the drilling rig located on a terrestrial pad.

The drilling rig 1r may include a derrick 3, a floor 4, a top drive 5, and a hoist. The top drive 5 may include a motor for rotating 21t the drill string 10. The top drive motor may be electric or hydraulic. A frame of the top drive 5 may be linked to a rail (not shown) of the derrick 3 for preventing rotation thereof during rotation of the drill string 10 and allowing for vertical movement of the top drive with a traveling block 6 of the hoist. The frame of the top drive 5 may be suspended from the derrick 3 by the traveling block 6. A quill of the top drive 5 may be torsionally driven by the top drive motor and supported from the frame by bearings. The top drive 5 may further have an inlet connected to the frame and in fluid communication with the quill. The traveling block 6 may be supported by wire rope 7 connected at its upper end to a crown block 8. The wire rope 7 may be woven through sheaves of the blocks 6, 8 and extend to drawworks 9 for reeling thereof, thereby raising or lowering the traveling block 6 relative to the derrick 3. The drilling rig 1r may further include a drill string compensator (not shown) to account for heave of the MODU 1m. The drill string compensator may be disposed between the traveling block 6 and the top drive 5 (aka hook mounted) or between the crown block 8 and the derrick 3 (aka top mounted).

Alternatively, a Kelly and rotary table (not shown) may be used instead of the top drive.

An upper end of the drill string 10 may be connected to a quill of the top drive 5, such as by threaded couplings. The drill string 10 may include a bottomhole assembly (BHA) 10b and a conveyor string 10p. The conveyor string 10p may include joints of drill pipe connected together, such as by threaded couplings. An upper end of the BHA 10b may be connected a lower end of the conveyor string 10p, such as by threaded couplings.

Alternatively, a Kelly valve may connect the drill string to the quill. Alternatively, the drill string may be connected to the Kelly valve/quill by a gripper (not shown), such as a torque head or spear.

The fluid transport system 1t may include an upper marine riser package (UMRP) 20 and a marine riser 25r. The riser 25r may extend from the PCA 1p to the MODU 1m and may connect to the MODU via the UMRP 20. The UMRP 20 may include a diverter, a flex joint, a slip (aka telescopic) joint, and a tensioner. The slip joint may include an outer barrel connected to an upper end of the riser 25r, such as by a flanged connection, and an inner barrel connected to the flex joint, such as by a flanged connection. The outer barrel may also be connected to the tensioner, such as by a tensioner ring (not shown).

The flex joint may also connect to the diverter, such as by a flanged connection. The diverter may also be connected to the rig floor 4, such as by a bracket. The slip joint may be operable to extend and retract in response to heave of the MODU 1m relative to the riser 25r while the tensioner may reel wire rope in response to the heave, thereby supporting the riser 25r from the MODU 1m while accommodating the heave. The riser 25r may have one or more buoyancy modules (not shown) disposed therealong to reduce load on the tensioner.

The PCA 1p may be connected to a wellhead 30 located adjacently to a floor 2f (aka mudline) of the sea 2. A conductor string 31 may be driven into the seafloor 2f. The conductor string 31 may include a housing and joints of conductor pipe connected together, such as by threaded couplings. Once the conductor string 31 has been set, a subsea wellbore 39b may be drilled into the seafloor 2f and a casing string 32 may be deployed into the wellbore. The casing string 32 may include a wellhead housing and joints of casing connected together, such as by threaded couplings. The wellhead housing may land in the conductor housing during deployment of a casing string 32. The casing string 32 may be cemented 39c into the wellbore 39b. The casing string 32 may extend to a depth adjacent a bottom of an upper formation. The upper formation may be non-productive and a lower formation may be a hydrocarbon-bearing reservoir.

Alternatively, the lower formation 27b may be non-productive (e.g., a depleted zone), environmentally sensitive, such as an aquifer, or unstable. Although shown as vertical, the wellbore 39b may include a vertical portion and a deviated, such as horizontal, portion.

The casing string 32 may have a casing antenna 37 disposed adjacent a bottom thereof. The casing antenna 37 may be a sub that connects with other members of the casing string, such as by threaded couplings. The casing antenna 37 may include two annular members that are mounted concentrically onto a casing joint. The two antenna members may be substantially identical and may be made from a metal or alloy. A radial gap may be formed between each of the antenna members and the casing joint and may be filled with an insulating material, such as a polymer. The casing antenna 37 may be in electrical communication with an electrical coupling disposed in the wellhead 30 via a cable extending along an outer annulus formed between the casing string and the wellbore 39b.

Alternatively, the cable may extend along a wall of the casing string. Alternatively, the casing antenna may be a gap sub.

The PCA 1p may include a wellhead adapter 40, one or more blow out preventers (BOPs) 41a,r a flow cross 42, a lower marine riser package (LMRP) 43, a receiver 46, and one or more accumulators (not shown). The LMRP 43 may include a control pod 44, a flex joint 43f, and a riser adapter 43a. The wellhead adapter 40, BOPs 41a,r, flow cross 42, riser adapter 43a, flex joint 43f, and receiver 46 may each include a housing having a longitudinal bore therethrough and may each be connected, such as by flanges, such that a continuous bore is maintained therethrough. The bore may have a drift diameter, corresponding to a drift diameter of the wellhead 30. The UMRP flex joint and LMRP flex joint 44f may accommodate horizontal and/or rotational (aka pitch and roll) movement of the MODU 1m relative to the riser 25r and the riser relative to the PCA 1p.

Each of the adapters 40, 43a may include one or more fasteners, such as dogs, for fastening the for fastening the LMRP 43 to the BOPs 41a,r and the PCA 1p to an external profile of the wellhead housing, respectively. Each of the adapters 40, 43a may further include a seal sleeve for engaging an internal profile of the respective receiver 31 and wellhead housing. Each of the adapters 40, 43a may be in electric or hydraulic communication with the control pod 44 and/or further include an electric or hydraulic actuator and an interface, such as a hot stab, so that a remotely operated subsea vehicle (ROV) (not shown) may operate the actuator for engaging the dogs with the respective external profile.

The LMRP 43 may receive a lower end of the riser 25r and connect the riser to the PCA 1p. The control pod 44 may be in electric, hydraulic, and/or optical communication with a programmable logic controller (PLC) 23 onboard the MODU 1m via an umbilical 25u. The control pod 44 may include one or more control valves (not shown) in communication with the BOPs 41a,r for operation thereof. Each pod control valve may include an electric or hydraulic actuator in communication with the umbilical 25u. The umbilical 25u may include one or more hydraulic and/or electric control conduit/cables for the actuators. The accumulators may store pressurized hydraulic fluid for operating the BOPs 41a,r. Additionally, the accumulators may be used for operating one or more of the other components of the PCA 1p. The control pod 44 may further include control valves for operating the other functions of the PCA 1p. The PLC 23 may operate the PCA 1p via the umbilical 25u and the control pod 44.

One or more lines (not shown), such as a booster line, kill line and/or choke line, may connect to the flow cross 42 and extend to the MODU 1m. A pressure sensor 45 may be connected to the flow cross 42. The pressure sensor 45 may be in data communication with the control pod 44. The casing antenna 37 may be in electrical communication with the control pod 44. The umbilical 25u may extend between the MODU 1m and the PCA 1p by being fastened to brackets disposed along the riser 25r.

Alternatively, the umbilical may be extend between the MODU and the PCA independently of the riser.

The fluid handling system 1h may include a mud pump 24, a solids separator, such as a shale shaker 26, and one or more gauges and/or sensors, such as pressure sensor 27p and stroke counter 27c, a reservoir for drilling fluid 22f, such as a tank 28, and one or more flow lines, such as a feed line 29f, a supply line 29s and a return line 29r. A lower end of the supply line 29s may be connected to an outlet of the mud pump 24 and an upper end of the supply line may be connected to the top drive inlet. The pressure sensor 27p may be assembled as part of the supply line and may be operable to monitor standpipe pressure. The pressure sensor 27 may be in data communication with the PLC 23. The PLC 23 may also be in data communication with the stroke counter 27c for monitoring a flow rate of the drilling fluid 22f pumped into the drill string 10. A lower end of the feed line 29f may be connected to an outlet of the tank 28 and an upper end of the feed line may be connected to an inlet of the mud pump 24. A first end of the return line 29r may be connected to the diverter outlet and a second end of the return line may be connected to an inlet of the shaker 26.

The mud pump 24 may pump the drilling fluid 22f from the tank 28, through the supply line 29s to the top drive inlet. The drilling fluid 22f may include a base liquid. The base liquid may be base oil, water, brine, or a water/oil emulsion. The base oil may be diesel, kerosene, naphtha, mineral oil, or synthetic oil. The drilling fluid 22f may further include solids dissolved or suspended in the base liquid, such as organophilic clay, lignite, and/or asphalt, thereby forming a mud.

The drilling fluid 22f may flow through the top drive 5 and into the drill string 10. The drilling fluid 22f may be pumped down through the drill string 10 and exit a drill bit 15 of the BHA 10b, where the fluid may circulate the cuttings away from the bit and return the cuttings up an annulus 39a formed between an inner surface of the casing 32 or wellbore 39b and an outer surface of the drill string 10. The returns 22r (drilling fluid 22f plus cuttings) may flow through the annulus 39a to an annulus of the wellhead 30. The returns 22r may continue through annuli of the PCA 1p, riser 25r, and UMRP 20 to the return line 29r. The returns 22r may flow through the return line 29r and be processed by the shale shaker 26 to remove the cuttings. The processed return fluid may then be reused as drilling fluid. As the drilling fluid 22f circulates, the drill string 10 may be rotated 21t by the top drive 5 and lowered by the traveling block 6, thereby extending the wellbore 39b into the lower formation.

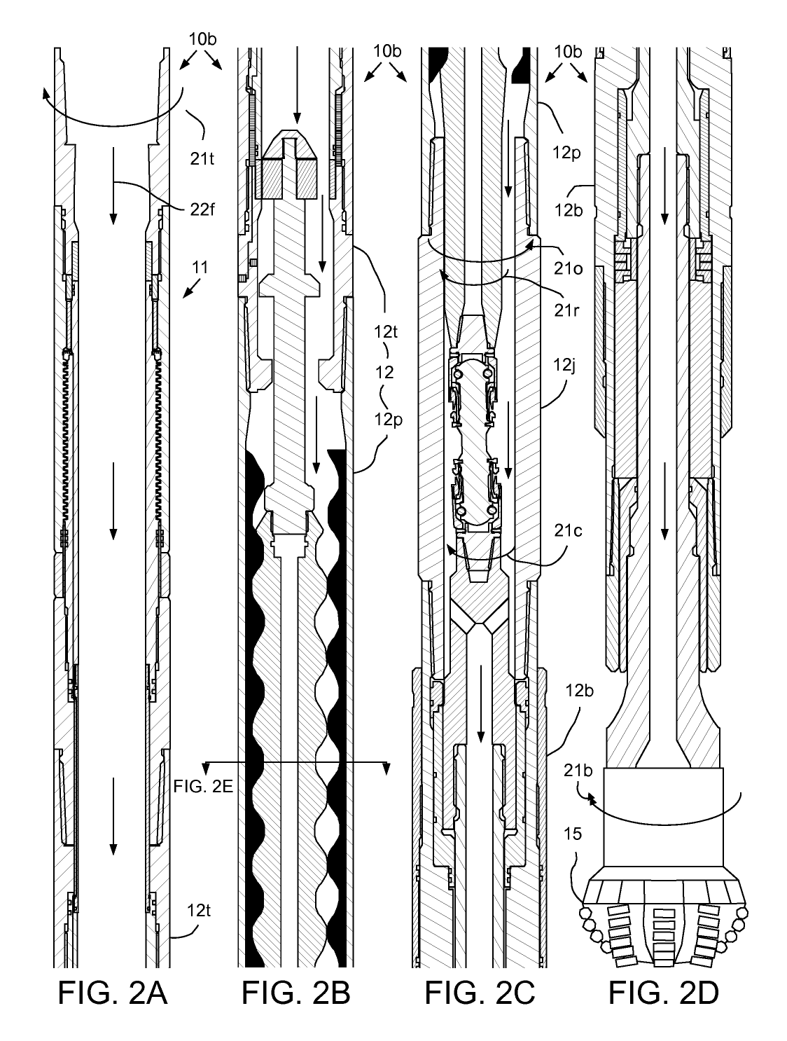

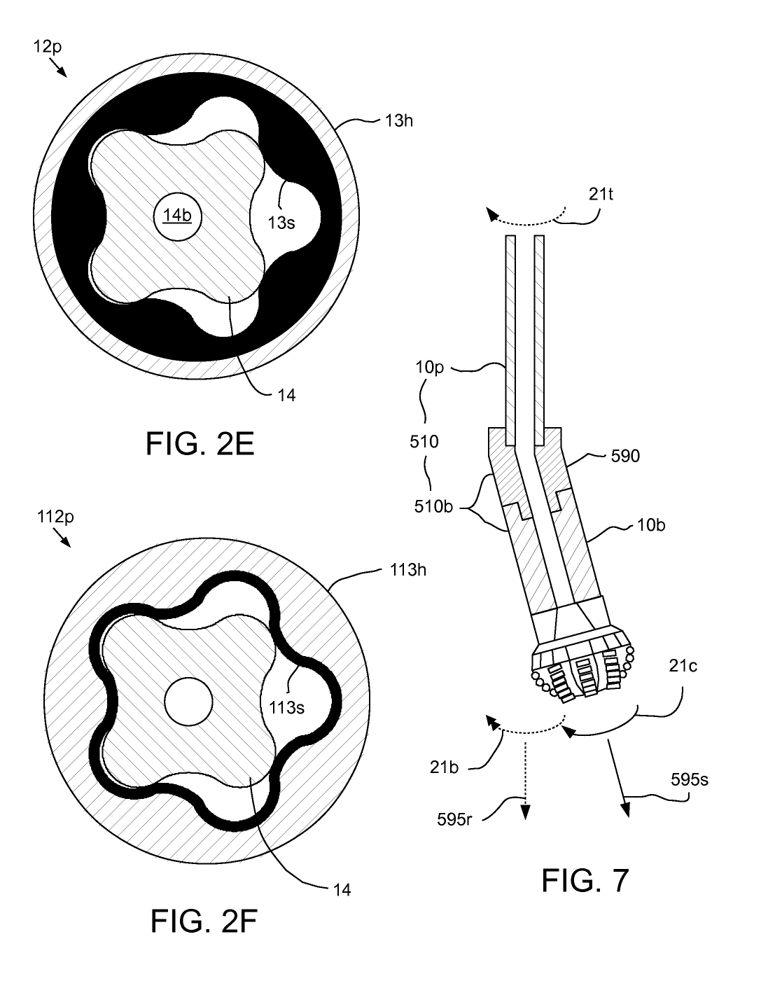

FIGS. 2A-2E illustrate the BHA 10b. The BHA 10b may include a telemetry sub, such as a gap sub 11, a drilling motor 12, one or more drill collars (not shown), and a drill bit 15. Housings of the BHA components may be connected, such as by threaded couplings, and shafts of the BHA components may be connected, such as by threaded or splined couplings.

The gap sub 11 may include a housing, a mandrel, and one or more gap rings (two shown) electrically isolating the housing from the mandrel. Each of the housing and the mandrel may include two or more sections (two shown for each) connected together, such as by threaded couplings. The housing may have a threaded coupling formed at an upper end thereof for connection to the conveyor string 10p. The mandrel may have an external threadform having widely spaced adjacent threads and the housing may have a mating internal threadform with widely spaced threads. A dielectric material, such as a polymer, may fill the threadspace.

An outer one of the gap rings of the gap sub 11 may be constructed from an abrasion resistant dielectric material, such as a ceramic or cermet, to support the housing-mandrel joint under bending and compressive loading. A primary external seal may be formed by compressing the outer gap ring between the housing and the mandrel. A secondary seal arrangement may be disposed adjacent the outer gap ring. An internal, non-conductive seal arrangement may be disposed in an annulus formed between the housing and the mandrel. The inner gap ring may be exposed to a bore of the gap sub and may be formed from a high temperature, high strength dielectric material, such as a polymer. A plurality of non-conductive torsion pins may be disposed between the housing and the mandrel to ensure that no relative rotation between the mandrel and housing may occur, even if the threadspace fill fails. The torsion pins may each be cylindrical and may be disposed in matching machined grooves formed in facing surfaces of the housing and the mandrel.

The motor 12 may be a positive displacement motor, such as a progressive cavity motor (PCM, aka: Moineau, mud, or helimotor). The motor 12 may include a dump valve (not shown), a tachometer 12t, a power section 12p, a mechanical joint 12j, and a bearing section 12b.

The power section 12p may harness fluid energy from the drilling fluid 22f and utilize the harnessed energy to rotationally drive the drill bit 15. The power section 12p may include a rotor 14, a stator 13s, and a stator housing 13h. The rotor 14 and stator housing 13h may be made from a metal or alloy, such as a steel, or a corrosion resistant alloy, such as a nickel based alloy. The steel may be plain carbon, low alloy, or stainless. The stator 13s may be made from an elastomer or an elastomeric copolymer, such as nitrile rubber or a fluoroelastomer.

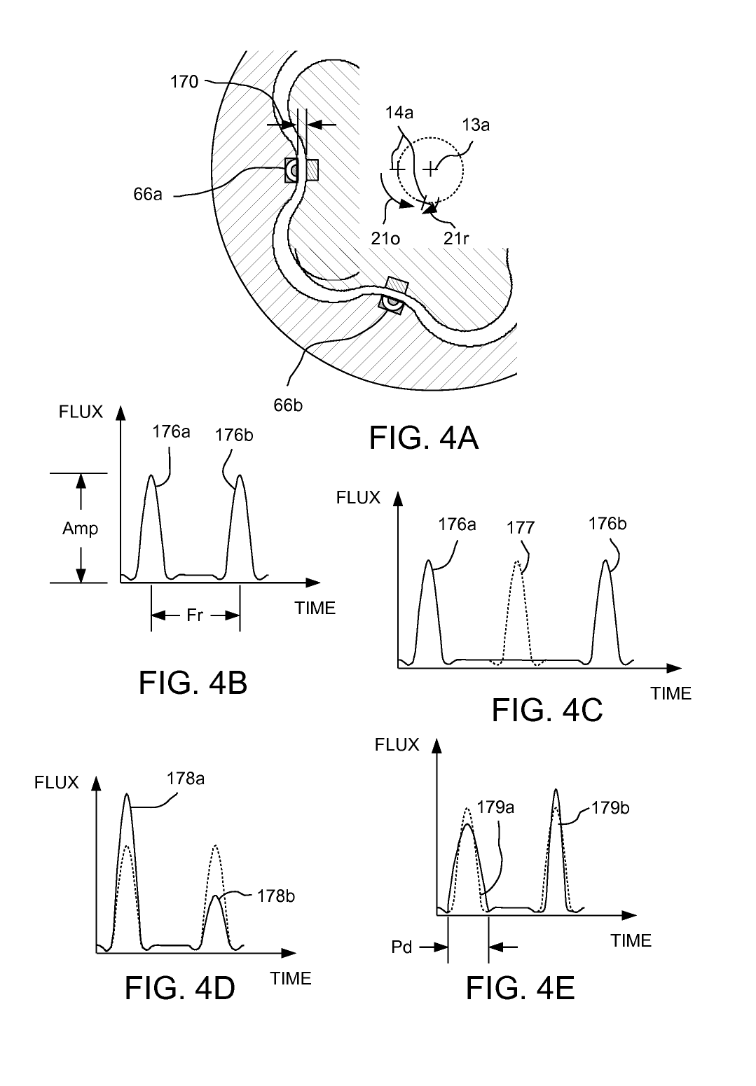

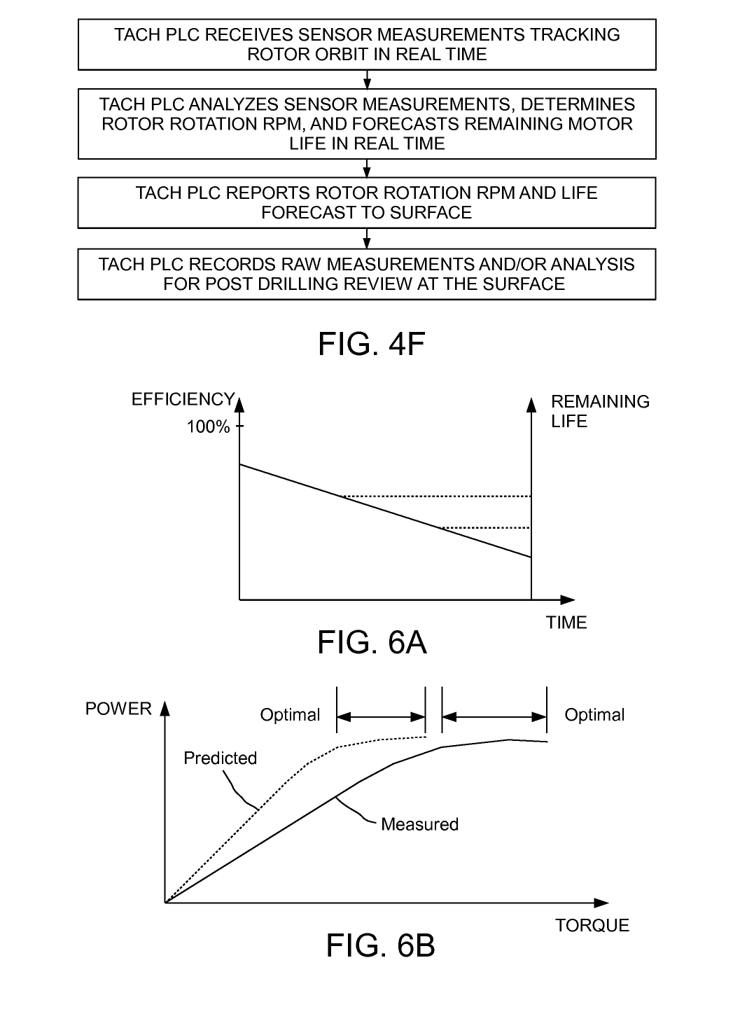

The rotor 14 may have one or more lobes (four shown) formed in an outer surface thereof and helically extending therealong. For interaction with the rotor lobes, the stator 13s may have two or more lobes (five shown: equal to the number of rotor lobes plus one) formed in an outer surface thereof and helically extending therealong. The power section 12p may be characterized as a ratio of rotor lobes to stator lobes, such as four:five, and may range from one:two to eleven:twelve. The rotor 14 and stator 13s may interact at the helical lobes to form a plurality of cavities (aka chambers) and sealing surfaces isolating the cavities from the each other. To effectuate the seal, the rotor 14 and stator 13s may be sized to form an interference fit. The interference may range between five and thirty thousandths of an inch, such as ten thousandths. As the drilling fluid 22f is pumped through the cavities, a longitudinal axis 14a (FIG. 4A) of the rotor 14 orbits (aka precesses or nutates) about a longitudinal axis 13a of the stator 13s. As the rotor 14 orbits within the stator 13s, the rotor also rotates 21r about its own longitudinal axis 14a at a velocity opposite to and proportional to the orbital velocity by the number of rotor lobes (as shown: rotational velocity equals orbital velocity divided by negative four).

FIG. 2F illustrates an alternative power section 112p for use with the motor 12 instead of the power section 12p, according to another embodiment of the present disclosure. The stator housing 113h may have the lobed profile formed in an inner surface thereof, thereby allowing a thickness of the stator 113s to be reduced and to be uniform.

The mechanical joint 12j may receive the eccentric motion 21o,r of the rotor 14 and convert the eccentric motion into concentric rotation 21c for driving the bit 15. Since the BHA housings may be also rotated 21t by the top drive 5, the rotation 21b of the bit relative to bottomhole may equal the sum (depicted by double arrows) of the concentric rotation 21c output by the mechanical joint 10j and the top drive rotation 21t. The bearing section 12b may include one or more radial bearings and one or more thrust bearings for supporting rotation of the drill bit 15 from the bearing section housing. The bearings may be lubricated by drilling fluid or the bearing section may include a balanced lubricant system.

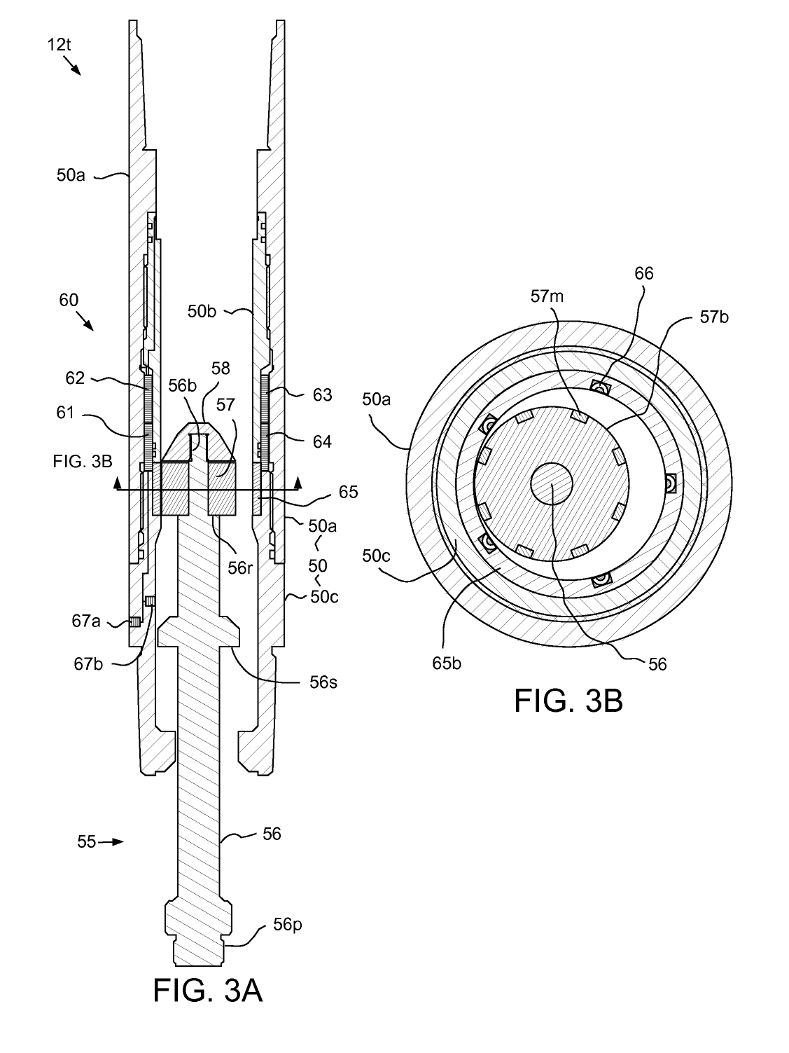

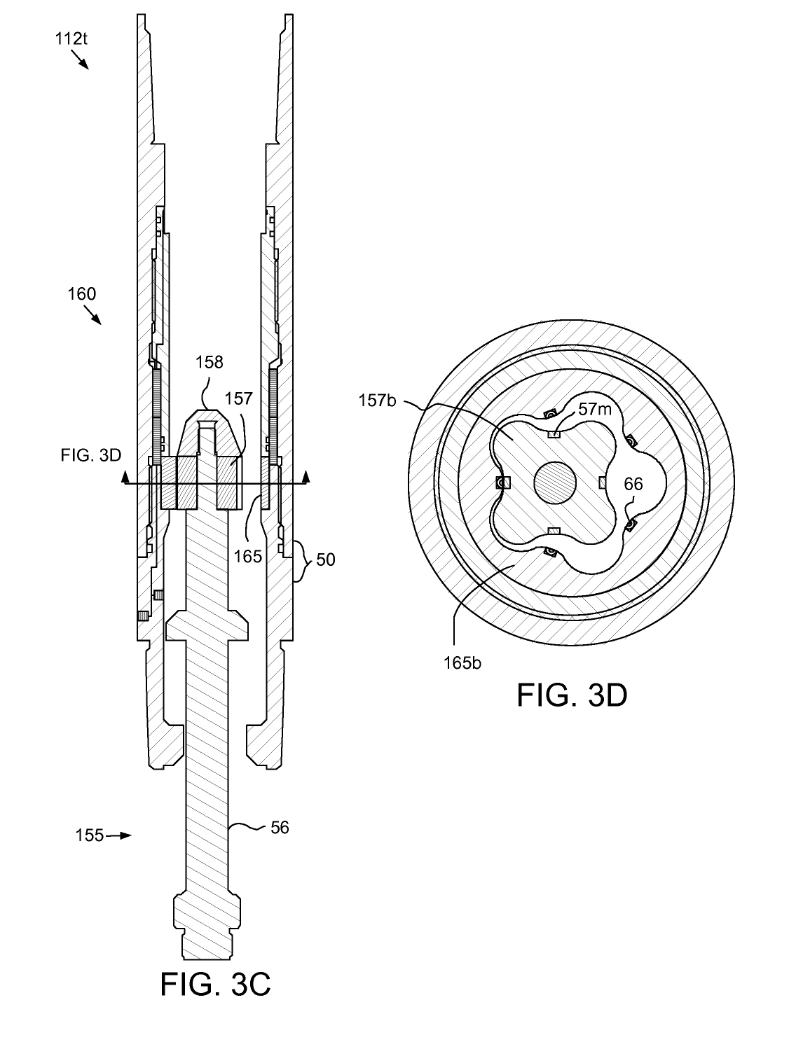

FIGS. 3A and 3B illustrate the tachometer 12t. The tachometer 12t may include a housing 50, a probe 55, and electronics 60. The housing 50 may include two or more tubular sections 50a-c connected to each other, such as by threaded connections. The housing 50 may have couplings, such as a threaded couplings, formed at a top and bottom thereof for connection to the gap sub 11 and stator housing 13h, respectively. An annulus may be formed between an upper housing section 50a and a mid housing section 50b for receiving components 61-64 of the electronics 60.

The probe 55 may include a shaft 56, a target array 57, and a fastener 58. The shaft 56 may have a coupling, such as a threaded coupling 56p, formed at a bottom thereof for connection to a top of the rotor 14. The shaft-rotor connection may connect the probe 55 to the rotor 14 longitudinally, torsionally, and transversely such that the probe 210 orbits and rotates 21r with the rotor. A rotor catch shoulder 56s may be formed in an outer surface of the shaft 56. The rotor catch shoulder 56s may be sized for engaging a shoulder formed in an inner surface of the lower housing section 50c to facilitate deployment and/or removal of the BHA 10b. The fastener 58 may have a conical outer surface for diverting flow and be made from an erosion resistant material, such as a cermet.

The target array 57 may include a base 57b and one or more (eight shown) targets 57m. The base 57b may be annular and made from a nonmagnetic material, such as a metal, alloy, or engineering polymer. The base 57b may be received in a groove 56r formed in an outer surface of the shaft 56 and be restrained between a shoulder of the shaft and the fastener 58. An upper end of the shaft 56 may be threaded for receiving the fastener 58. The base 57b may be torsionally connected to the shaft 56, such as by bonding, press fit, threading, compression, or splines. The base 57b may have a recess formed in an outer surface thereof for receiving a respective target 57m. The recesses may be spaced around at the base 57b outer surface at regular intervals. Each target 57m may be a permanent magnet or be made from a magnetic material. Each target 57m may be retained in a respective recess, such as by bonding or press fit.

The electronics 60 may include a PLC 61, a transmitter 62, a data recorder 63 (i.e., solid state drive), a battery 64, a proximity sensor array 65, and one or more pressure sensors 67a,b. The pressure sensor 67a may be in fluid communication with the annulus 39a and the pressure sensor 67b may be in fluid communication with a bore of the housing 50. Components 61-67 of the electronics 60 may be in electrical communication with each other (and the housing 50) by leads, a bus (only partially shown), or integration on a printed circuit board. To avoid interference with the sensor array 65, each of the housing 50 and shaft 56 may be made from a nonmagnetic metal or alloy, such as austenitic stainless steel.

The sensor array 65 may include a base 65b and one or more (five shown) proximity sensors 66. The base 65b may be an annular member and be exposed to a bore of the housing. The base 65b may be made from a nonmagnetic material, such as a metal, alloy, or engineering polymer. The base 65b may be received in a groove formed in an inner surface of the lower housing section 50c and be restrained between a shoulder of the lower housing section and a bottom of the mid housing section. The base 65b may be torsionally connected to the housing 50, such as by bonding, press fit, threading, compression, or splines. Each proximity sensor 66 may be disposed in a recess formed in an inner surface of the base 65b and be retained therein, such as by bonding. Each sensor 66 may be contactless, such as a Hall effect sensor, and be located adjacent to the orbit 210 of the rotor 14. The number of proximity sensors 66 may correspond to the number of stator lobes and the proximity sensors may be spaced around the base 65b at regular intervals.

Each proximity sensor 66 may or may not include a biasing magnet depending on whether the targets 57m are permanent magnets. Each sensor 66 may include an encapsulation and a semiconductor housed therein and may be in electrical communication with the bus for receiving a regulated current. The encapsulation may be made from a nonconductive, nonmagnetic, and erosion resistant material, such as an engineering or thermoset polymer. The sensor 66 and/or targets 57m may be oriented so that the magnetic field generated by the biasing magnet or permanent magnet targets is perpendicular to the current. Each sensor 66 may further include an amplifier for amplifying the Hall voltage output by the semiconductor when one or more of the targets 57m are in proximity to the head.

Alternatively, the proximity sensors may be inductive, capacitive, or utilize radio frequency identification tags (RFID). Alternatively, the targets may be integrated with the base as teeth and the teeth may protrude from an outer surface of the integrated base.

FIG. 3B depicts the proximity sensors 66 misaligned with the targets 57m. Spacing many targets 57m around the probe base 57b may obviate the need to align the proximity sensors 66 with the targets. Even though the targets 57m may not be aligned with the proximity sensors 66 when the probe 55 is at a position along the orbit 210 adjacent one of the sensors, the sensors may still detect the presence of the probe 55, even if the Hall response is caused by the proximity of two misaligned targets 57m instead of one aligned target 57m. Spacing of the sensors 66 corresponding to the stator 13s and even spacing of multiple targets 57m around the probe base 57b may ensure that the misaligned Hall response is consistent throughout the orbit/rotation 21o,r of the probe/rotor 55, 14.

FIGS. 3C and 3D illustrate an alternative tachometer 112t for use with the drilling motor 12, according to another embodiment of the present disclosure. The tachometer 112t may include the housing 50, a probe 155, and electronics 160. The probe 155 may include the shaft 56, a target array 157, and a fastener 158. The electronics 160 may include the PLC 61, the transmitter 62, the data recorder 63, the battery 64, a proximity sensor array 165, and the one or more pressure sensors 67a,b.

The sensor array 165 may include a base 165b and one or more (five shown) of the proximity sensors 66. The base 165b may be an annular member and be exposed to a bore of the housing. The base 165b may have a two-dimensional (non-helical lobes) replica of the stator profile formed in an inner surface thereof. The replica may be to the same scale or be miniaturized. The base 165b may be made from a nonmagnetic material such as a metal, alloy, or engineering polymer. The base 165b may be received in a groove formed in an inner surface of the lower housing section 50c and be restrained between a shoulder of the lower housing section and a bottom of the mid housing section. The base 165b may be torsionally connected to the housing 50, such as by bonding, press fit, threading, or splines. Each proximity sensor 66 may be disposed in a recess formed in an inner surface of the base 165b and be retained therein, such as by bonding. The number of sensors 66 may correspond to the number of stator lobes and the sensor heads may be located in peaks (shown) of the lobes or valleys (not shown).

Alternatively, the number of sensors may be twice the number of stator lobes and the sensors may be disposed in the peaks and valleys.

The target array 157 may include a base 157b and one or more (four shown) targets 57m. The base 157b may be annular and made from a nonmagnetic material, such as a metal, alloy, or engineering polymer. The base 157b may have a two-dimensional (non-helical lobes) replica of the rotor profile formed in an outer surface thereof. The replica may be to the same scale or be miniaturized. The base 157b may be received in the shaft groove 56r and be compressed between a shoulder of the shaft and the fastener 158. The fastener 158 may have a conical outer surface for diverting flow and be made from an erosion resistant material, such as a cermet. The base 157b may be torsionally connected to the shaft 56 by the compression. The base 157b may have a recess formed in an outer surface thereof for receiving a respective target 57m. The recesses may be spaced around at the base outer surface at regular intervals. Each target 57m may be retained in a respective recess, such as by bonding or press fit. The number of targets 57m may correspond to the number of rotor lobes and the targets may be located in valleys (shown) of the lobes or peaks (not shown).

Alternatively, the number of targets 57m may be twice the number of rotor lobes and the targets may be disposed in the peaks and valleys.

The bases 157b, 165b may be sized so that a radial clearance 170 exists when the probe 155 is at a position along the orbit 210 adjacent one of the sensors 66. The radial clearance 170 may correspond to one-half of the rotor-stator interference, such as being equal to or slightly greater than the one-half interference. Since interaction of the profiled bases 157b, 165b may mimic operation of the power section 12p, alignment of the bases may be necessary. Since the rotational position of the sensor base 165b may be fixed by connection to the stator housing 13s, the sensor array 157 may rotate freely on the shaft 56 until the fastener 158 is tightened to accommodate alignment of the bases 157b, 165b during assembly of the motor 12.

FIGS. 4A-4F illustrate operation of the alternative tachometer 112t. The tachometer 12t may also operate in a similar fashion. In operation, as the rotor 14 orbits/rotates 21o,r within the stator 13s, the sensors 66a,b may detect proximity of the respective target 57m and generate respective Hall responses 176a,b. The tachometer PLC 61 may monitor the pressure sensor 67b and/or the sensors 66 to determine when drilling has commenced. Once drilling has commenced, the tachometer PLC 61 may receive the Hall responses 176a,b and determine orbital speed of the rotor 14 based on a frequency Fr of the Hall responses 176a,b and the number of sensors 66. Once the orbital speed has been determined, the tachometer PLC 61 may determine the angular speed as discussed above. The tachometer PLC 61 may also relay the Hall responses 176a,b to the data recorder 63 for analysis at the MODU 1m after the drill string 10 has been retrieved.

The tachometer PLC 61 may then transmit the angular speed to the rig PLC 23 by sending the data to the transmitter 62. The transmitter 62 may be in electrical communication with the gap sub 11 via electrical couplings, such as contacts and/or wireless couplings, and a stinger. The transmitter 62 may modulate upper and lower portions of the BHA isolated by the gap sub 11, thereby generating an electromagnetic wave 38. The casing antenna 37 may receive the electromagnetic wave 38 and relay the angular speed to the control pod 44 via the cable. The control pod 44 may then relay the angular speed data to the rig PLC 23 via the umbilical 25u. The rig PLC 23 may display the angular speed for the driller. The PLC 61 may determine both instantaneous angular speed and average angular speed (i.e., using five or more instantaneous measurements) and may transmit one or both to the rig PLC 23 depending on uplink data rate. The tachometer PLC 61 may iteratively repeat speed monitoring during drilling in real time.

Alternatively, a mud pulser, acoustic transmitter, toroidal antenna (transverse EM), or wired drill pipe may be used instead of the gap sub.

The tachometer PLC 61 may utilize pressure measurements from the sensors 67a,b to estimate a torque output by the power section 12p. The tachometer PLC 61 may estimate a discharge pressure of the motor power section 12p using the annulus pressure measurement from the sensor 67a. The tachometer PLC 61 may estimate the drilling flow rate using the orbital or angular speed of the rotor 14 and known geometry of the power section 12p (i.e., specific displacement). The tachometer PLC 61 may estimate the pressure loss through the bit 15 using the estimated drilling flow rate and known geometry of the bit 15. The tachometer PLC 61 may then add the pressure loss through the bit 15 to the annulus pressure measurement from the sensor 67a to determine the discharge pressure of the motor power section 12p. The tachometer PLC 61 may then estimate the torque using the power section differential pressure (bore pressure (from pressure sensor 67b) minus discharge pressure), the geometry of the power section, and a predetermined efficiency (i.e., six-tenths to eight-tenths: depending on the lobe ratio).

The tachometer PLC 61 may also utilize the Hall responses 176a,b to monitor health of the power section 12p. The tachometer PLC 61 may have one or more criteria for monitoring the power section health. A first criterion may include counting motor stalls 177. The tachometer PLC 61 may detect the motor stall 177 by zeroing instantaneous velocity if a Hall response 176a,b has not been detected for a predetermined period. The predetermined period may be determined using a fraction of the expected motor speed during drilling, such as one-half of the expected motor speed. The tachometer PLC 61 may then subtract the detected stall 177 from a predetermined number of stalls corresponding to a lifespan of the motor. The tachometer PLC 61 may then transmit the remaining lifespan to the rig PLC 23 for display to the driller.

Alternatively, the tachometer PLC 61 may calculate a stall parameter based on a length of the stall and/or an increase in pressure detected by monitoring the bore pressure sensor 67b. The tachometer PLC 61 may then subtract the stall parameter from a predetermined stall parameter corresponding to the lifespan of the motor and transmit the remaining lifespan to the rig PLC 23.

Another criterion may include monitoring an amplitude Amp of the Hall responses 176a,b as an indicator of stator wear. The amplitude Amp of the Hall responses 176a,b may be proportional to the radial clearance 170. As the stator 13s wears, the rotor orbit 210 may become eccentric about the stator centerline 13a and this eccentricity may be reflected in amplitude variations 178a,b of the Hall responses 176a,b. The tachometer PLC 61 may compare the amplitude Amp of the Hall responses 178a,b to a predetermined amplitude or the PLC may record the amplitude Amp of the Hall responses 176a,b at the commencement of drilling (before the stator 13s wears). The tachometer PLC 61 may then compare the deviation to one or more predetermined deviation thresholds corresponding to remaining lifespan of the motor 12 and transmit the remaining lifespan to the rig PLC 23.

Another criterion may include monitoring the Hall responses 176a,b for distortion 179a,b. The distortion 179a,b may be in the amplitude Amp and/or period Pd of an individual Hall response. The tachometer PLC 61 may monitor distortion 179a,b by calculation of a distortion parameter (i.e., amplitude Amp multiplied by period Pd). The tachometer PLC 61 may then compare the distortion parameter to a predetermined distortion parameter or the PLC may record the distortion parameter of the Hall responses 176a,b at the commencement of drilling (before the stator 13s wears). The tachometer PLC 61 may then compare the deviation to one or more predetermined deviation thresholds corresponding to remaining lifespan of the motor 12 and transmit the remaining lifespan to the rig PLC 23.

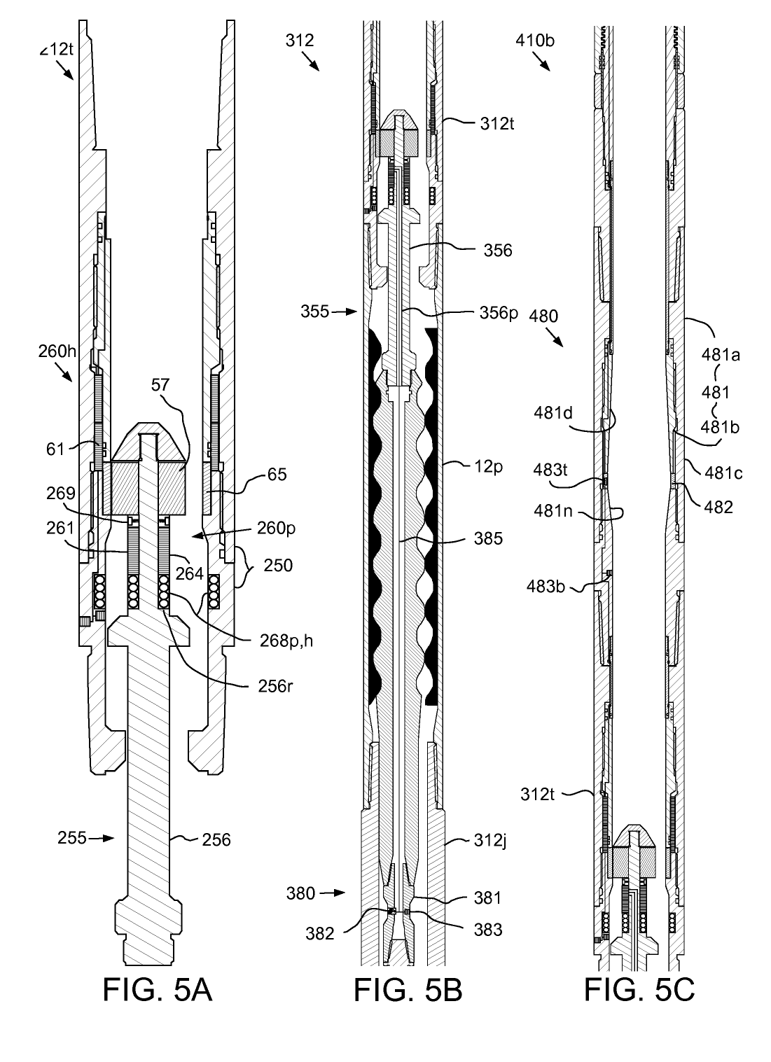

FIG. 5A illustrates another alternative tachometer 212t for use with the drilling motor 12, according to another embodiment of the present disclosure. The tachometer 212t may include a housing 250, a probe 255, and housing electronics 260h. The housing 250 may include two or more (three shown) tubular sections connected to each other, such as by threaded couplings. The housing 250 may have couplings, such as a threaded couplings, formed at a top and bottom thereof for connection to the gap sub 11 and stator housing 13h, respectively. An annulus may be formed between an upper housing section and a mid housing section for receiving components of the housing electronics 260h.

The probe 255 may include a shaft 256, electronics 260p, the target array 57, and the fastener 58. The housing electronics 260h may include the PLC 61, the transmitter 62, the data recorder 63, the battery 64, the proximity sensor array 65, the one or more pressure sensors 67a,b, and a wireless data coupling 268h. The probe electronics 260p may include a PLC 261, a battery 264, a wireless data coupling 268h, and one or more (two shown) angular speed sensors 269. Respective components of each of the electronics 260p,h may be in electrical communication with each other by leads, a bus, or integration on a printed circuit board. To avoid interference with the proximity sensors, the housing 250 and shaft 256 may be made from a nonmagnetic metal or alloy, such as austenitic stainless steel. Alternatively, the tachometer 212t may include the sensor array 165 and the target array 157 of the alternative tachometer 112t.

The shaft 256 may have a coupling, such as a threaded coupling 56p, formed at a bottom thereof for connection to a top of the rotor 14. The shaft-rotor connection may connect the probe 255 to the rotor 14 longitudinally, torsionally, and transversely such that the probe 210 orbits and rotates 21r with the rotor. The shaft 256 may have the rotor catch shoulder 56s. The shaft 256 may also have a groove 256r formed in an outer surface thereof for receiving the probe electronics 260p and the target array 57 and a threaded upper end for receiving the fastener 58.

The angular speed sensors 269 may each be single axis accelerometers. The accelerometers may be piezoelectric, magnetostrictive, servo-controlled, reverse pendular, or microelectromechanical (MEMS). The accelerometers may be radially oriented relative to the shaft 256 to measure the centrifugal acceleration due to rotation of the probe 255 for determining the angular speed. Multiple speed sensors 269 may be spaced around the shaft 255 to account for centrifugal acceleration due to orbiting of the probe, lateral vibration, and/or gravity if the BHA 10b is used for deviated or horizontal drilling (FIG. 7).

The shaft PLC 261 may receive the measurements from the angular speed sensors 269 in real time and iteratively during drilling. The shaft PLC 261 may process the measurements to determine angular speed of the rotor 14. The shaft PLC 261 may then transmit the angular speed to the housing PLC 61 via the data couplings 268p,h. The housing PLC 61 may monitor the measured angular speed iteratively and in real time during drilling and may relay the measured angular speed to the data recorder 63. The housing PLC 61 may utilize the measured angular speed to detect the motor stall 177 instead of having to rely on the predetermined period, discussed above. The housing PLC 61 may detect the motor stall 177 when the (instantaneous) measured angular speed is zero or substantially zero.

Alternatively, the housing PLC 61 may calculate a rate of change of the measured angular speed with respect to time (angular acceleration), and use the angular acceleration for the calculation of the stall parameter. The housing PLC 61 may compare the measured angular speed to the determined angular speed (from the proximity sensors 66) and use the comparison as an additional criterion for motor health. The housing PLC 61 may report either, both, or an average of the angular speeds to the rig PLC 23 as instantaneous angular speed and utilize either or both for the average angular speed calculation.

Alternatively, the angular speed sensors may be used instead of the proximity sensors 66 and the proximity sensors and target array may be omitted. Alternatively, the probe battery may be omitted and the probe electronics may be powered using wireless power couplings, further using the data couplings as wireless power couplings, or adding a generator to the tachometer utilizing the rotation of the probe relative to the housing to generate electricity. The generator may deliver electricity at the housing and/or at the probe and may also obviate the need for the housing battery or allow substitution of a capacitor for the housing battery.

FIG. 5B illustrates a portion of an alternative motor 312 for use with the BHA 10b, according to another embodiment of the present disclosure. The motor 312 may include a dump valve (not shown), a tachometer 312t, the power section 12p, an auxiliary probe 380, a mechanical joint 312j, and the bearing section 12b. The mechanical joint 312j may be similar to the mechanical joint 12j except that a housing thereof may be lengthened to accommodate the auxiliary probe 380. The tachometer 312t may be similar to the tachometer 212t except that a shaft 356 has been substituted for the shaft 256. The shaft 356 may be similar to the shaft 256 except that the shaft 356 has a passage 356p formed therein for extension of a cable 385 from the shaft PLC 261 to the auxiliary probe 380. The cable may also extend through a bore 14b of the rotor 14.

Alternatively, the auxiliary probe may have its own housing. Alternatively, the power section 112p may be used instead of the power section 12p.

The auxiliary probe 380 may include a shaft 381 and one or more sensors, such as a strain gage 382 and a pressure sensor 383. The pressure sensor 383 may be in fluid communication with a chamber formed between a lower end of the rotor 14 and a housing of the mechanical joint 312j for measuring a discharge pressure of the power section 12p. The strain gage 382 may be foil, semiconductor, piezoelectric, or magnetostrictive. The strain gage 382 may be oriented at a forty-five degree angle relative to a longitudinal axis of the shaft 381 to measure torsional strain of the shaft 381 due to output torque exerted by the rotor 14. Additional strain gages may be disposed on the shaft to account for temperature and/or increase sensitivity.

The shaft PLC 261 may supply power to and receive measurements from the sensors 382, 383 in real time and iteratively during drilling. The shaft PLC 261 may process the measurements to determine output torque of the rotor 14 and discharge pressure of the power section. The shaft PLC 261 may then transmit the angular speed measurement to the housing PLC 61 via the data couplings 268p,h. If the auxiliary probe 380 includes only the pressure sensor 383, then the housing PLC 61 may then not need to estimate discharge pressure of the power section using the annulus pressure sensor 67a. If the auxiliary sub 380 includes the strain gage 382, then the housing PLC 61 may then not need to calculate the output torque using the pressure sensors 67b, 383. The housing PLC 61 may relay the extraneous pressure measurements to the data recorder 63 and may send the measurements to the rig PLC 23 if allowed by the uplink data rate.

Alternatively, the auxiliary probe may be in communication with the tachometer via wireless telemetry instead of the cable. Alternatively, the auxiliary probe may be used with either of the tachometers 12t, 112t.

FIG. 5C illustrates a portion of an alternative BHA 410b, according to another embodiment of the present disclosure. The BHA 410b may be connected to the conveyor string 10p, such as by threaded couplings. The BHA 410b may include the gap sub 11, a flow meter 480, the drilling motor 312, one or more drill collars (not shown), and the drill bit 15. Housings of the BHA components may be connected, such as by threaded couplings, and shafts of the BHA components may be connected, such as by threaded or splined couplings.

The flow meter 480 may be solid state, such as a reverse Venturi flow meter. The flow meter 480 may include a housing 481, a plenum (aka reverse throat) 482, and one or more pressure sensors 483b,t. The housing 481 may include two or more tubular sections 481a-c connected to each other, such as by threaded connections. The housing 481 may have couplings, such as threaded couplings, formed at a top and bottom thereof for connection to the gap sub 11 and tachometer housing 250, respectively.

An inner surface of a mid housing section 481b may be conical and the housing section oriented to serve as a diffuser 481d and an inner surface of a lower housing section 481c may be conical and the housing section oriented to serve as a nozzle 481n. The plenum 482 may be disposed between the diffuser 481d and the nozzle 481n and have a pressure sensor 483t disposed therein in fluid communication with the housing bore. A pressure sensor 483b may be disposed downstream of the nozzle 481n and in fluid communication with the housing bore. The sensors 483b,t may be in electrical communication with the housing PLC 61 via electrical couplings, such as contacts and/or wireless couplings, and a stinger.

FIG. 6A illustrates operation of the alternative BHA 410b, according to another embodiment of the present disclosure. The housing PLC 61 may supply power to and receive measurements from the sensors 483b,t in real time and iteratively during drilling. The housing PLC 61 may process the measurements to determine differential pressure of the nozzle 481n. The housing PLC 61 may then use known geometry of the flow meter 480 and an expected density of the drilling fluid 22f to calculate a volumetric flow rate. Once flow rate has been calculated, the housing PLC 61 may multiply flow rate and differential pressure across the power section to calculate input power to the power section 12p. The housing PLC 61 may also multiply the torque output by the power section 12p and the angular speed of the rotor 14 to calculate output power of the motor section. The housing PLC 61 may then divide output power by input power to obtain efficiency of the power section 12p. The housing PLC 61 may then compare the efficiency to a predetermined efficiency or the PLC may record the efficiency of at the commencement of drilling (before the stator 13s wears). The housing PLC 61 may then compare the efficiency to one or more predetermined efficiency thresholds corresponding to remaining lifespan of the motor 12 and transmit the remaining lifespan to the rig PLC 23.

FIG. 6B illustrates additional operation of the alternative BHA 410b, according to another embodiment of the present disclosure. The output power calculation may also be used to calibrate a predicted model of motor performance in order to optimize the motor performance for increasing rate of penetration (ROP). The motor model may be included in the rig PLC 23 and/or the housing PLC 61. As shown, the motor model has indicated a sub-optimal torque range to operate the motor. The output power may be sent to the rig PLC 23 by the housing PLC 61. The rig PLC 23 may then generate a calibrated model and illustrate a graphical comparison for the driller. The rig PLC 23 may then suggest adjustment of the torque (i.e., by adjusting weight on bit (WOB)) to obtain optimal motor performance and ROP.

FIG. 7 illustrates a directional BHA 510b, according to another embodiment of the present disclosure. The BHA 510b may be similar to the BHA 10b except for the addition of a bent sub 590. Alternatively, the BHA 410b may be used with the bent sub 590 instead of the BHA 10b. The directional BHA 510b may be operable in a rotary mode 595r or a sliding mode 595s. To operate in the sliding mode 595s, the conveyor string 10p may be held rotationally stationary and inclination of the drill bit 15 by the bent sub 590 may cause drilling along a curved trajectory. To operate in the rotary mode 595r, the drill string 10 may be rotated 21t by the top drive 5 to negate the curvature effect of the bent sub 590 (aka corkscrew path) and the drilling trajectory may be straight. To facilitate steering, the BHA 10b may further include a measurement while drilling (MWD) sub (not shown).

Alternatively, additional sensors, such as accelerometers and magnetometers, may be added to the tachometer 12t and/or auxiliary probe 380 to enable the PLC 61 to calculate navigation parameters, such as azimuth, inclination, and/or tool face angle. The tachometer PLC 61 may transmit the navigation parameters to the rig PLC 23 iteratively and in real time during drilling. The additional sensors may also be used to monitor vibration of the drill bit 15, such as bit bounce (longitudinal vibration) and/or lateral vibration iteratively and in real time during drilling. The additional sensors may also be used to monitor for decoupling of the drill bit 15 from the BHA 10b.

Alternatively, the conveyor string may be casing instead of drill pipe and the casing may be left in the wellbore and cemented in place instead of removing the drill string to install a second casing string. Alternatively, the conveyor string may be coiled tubing instead of drill pipe. If used for directional drilling, the coiled tubing BHA may further include an orienter having a second progressive cavity motor selectively engageable with the BHA via a clutch. A second tachometer and/or auxiliary probe may be used to monitor operation of the orienter motor. Alternatively, the BHA may further include a tractor for driving the drill string through the wellbore. A second tachometer and/or auxiliary probe may be used to monitor operation of the tractor motor.

Alternatively, any of the tachometers, auxiliary probe, and/or flow meter may be used with any other type of downhole motor, such as another type of positive displacement motor (i.e., reciprocating or vane motor) or a turbine motor.

Alternatively, the tachometer may monitor motor health using a stator wear sensor. The stator wear sensor may include a stator (not shown) similar to either one of the stators 13s, 113s except for being made from a polymer based composite. The composite may include a metal/alloy (i.e., copper, aluminum, gold, platinum, or silver) filled polymer resin or carbon-filled polymer resin. The filling may be non-spherical or irregular particles or nano-particles, such as grains, fibers, or tubes. The metal or alloy may be plated on another metal or alloy (i.e. silver plated nickel) or coated on glass beads to reduce cost. The polymer resin may be filled near, to, or past the percolation threshold. Electricity may be connected across the composite stator and the resistance monitored for wear. Alternatively, instead of a metal or alloy fill, the composite may be filled with a witness material, such as radioactive material, doped semiconductor, or a permanent magnet/magnetic material that will allow wear of the stator to be detected.

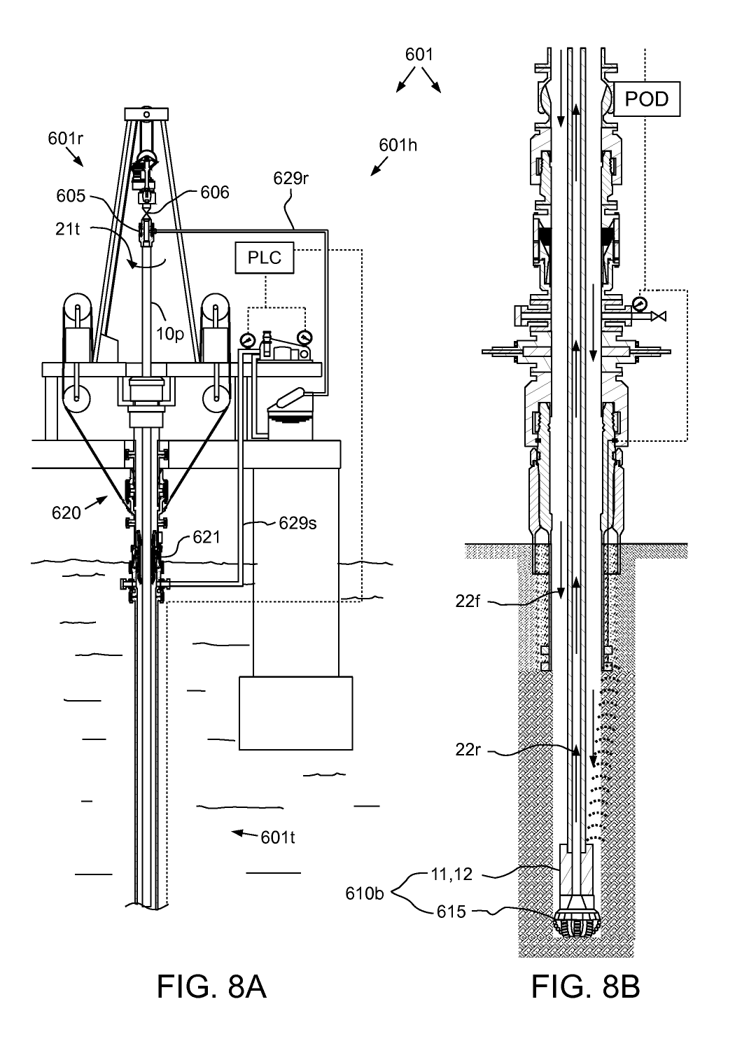

FIGS. 8A and 8B illustrate an offshore drilling system 601 in a reverse circulation mode, according to another embodiment of the present disclosure. The drilling system 601 may include the MODU 1m, a drilling rig 601r, a fluid handling system 601h, the fluid transport system 601t, the PCA 1p, and a drill string. The drilling rig 601r may include the derrick 3, the floor 4, the top drive 5, the hoist, a bypass swivel 605 and a Kelly valve 606. An upper end of the Kelly valve 606 may be connected to the quill, such as by threaded couplings and a lower end of the Kelly valve may be connected to an upper end of the bypass swivel, such as by threaded couplings.

The bypass swivel 605 may include a housing torsionally connected to the derrick 3, such as by bars, wire rope, or a bracket (not shown). The torsional connection may accommodate longitudinal movement of the swivel 605 relative to the derrick 3. The swivel 605 may further include a mandrel and bearings for supporting the housing from the mandrel while accommodating rotation 21t of the mandrel. The bypass swivel 605 may further include an outlet formed through a wall of the housing and in fluid communication with a port formed through the mandrel and a seal assembly for isolating the outlet-port communication. The mandrel port may provide fluid communication between a bore of the swivel and the housing outlet. Each seal assembly may include one or more stacks of V-shaped seal rings, such as opposing stacks, disposed between the mandrel and the housing and straddling the inlet-port interface.

Alternatively, the seal assembly may include rotary seals, such as mechanical face seals.

An upper end of the drill string may be connected to lower end of the bypass swivel 605, such as by threaded couplings. The drill string may include a bottomhole assembly (BHA) 610b and the conveyor string 10p. An upper end of the BHA 610b may be connected a lower end of the conveyor string 10p, such as by threaded couplings. The BHA 610b may include the gap sub 11, the drilling motor 12, one or more drill collars (not shown), and a reverse circulation drill bit 615.

Alternatively, the motor may include the power section 112p. Alternatively, the motor may include any of the tachometers 112t or 212t. Alternatively, the BHA may include the motor 312 and/or the flow meter 480.

The fluid transport system 601t may include an upper marine riser package (UMRP) 620 and the marine riser 25r. The UMRP 620 may include the diverter, the flex joint, the slip joint, the tensioner, and a rotating control device (RCD) 621. The RCD 621 may connect a lower end of the slip joint to an upper end of the riser 25r, such as by flanged connections. The RCD 621 may also be located adjacent to the waterline 2s.

The RCD 621 may include a docking station and a bearing assembly. The docking station may include a housing, a latch, and an interface. The RCD housing may be tubular and have one or more sections connected together, such as by flanged connections. The RCD housing may have one or more fluid ports formed through a lower housing section and the docking station may include a connection, such as a flanged outlet, fastened to one of the ports.

The latch may include a hydraulic actuator, such as a piston, one or more (two shown) fasteners, such as dogs, and a body. The latch body may be connected to the housing, such as by threaded couplings. A piston chamber may be formed between the latch body and a mid housing section. The latch body may have openings formed through a wall thereof for receiving the respective dogs. The latch piston may be disposed in the chamber and may carry seals isolating an upper portion of the chamber from a lower portion of the chamber. A cam surface may be formed on an inner surface of the piston for radially displacing the dogs. The latch body may further have a landing shoulder formed in an inner surface thereof for receiving the bearing assembly.

Hydraulic passages may be formed through the mid housing section and may provide fluid communication between the interface and respective portions of the hydraulic chamber for selective operation of the piston. An RCD umbilical (not shown) may have hydraulic conduits and may provide fluid communication between the RCD interface and a hydraulic power unit (HPU) (not shown) via hydraulic manifold (not shown). The RCD umbilical may further have an electric cable for providing data communication between a control console (not shown) and the RCD interface.

Alternatively, the docking station may be located along the UMRP 620 at any other location besides a lower end thereof. Alternatively, the docking station may be assembled as part of the riser 25r at any location therealong or as part of the PCA 1p.

The bearing assembly may include a catch sleeve, one or more strippers, and a bearing pack. Each stripper may include a gland or retainer and a seal. Each stripper seal may be directional and oriented to seal against the drill pipe in response to higher pressure in the riser 25r than the UMRP 20. Each stripper seal may have a conical shape for fluid pressure to act against a respective tapered surface thereof, thereby generating sealing pressure against the drill pipe. Each stripper seal may have an inner diameter slightly less than a pipe diameter of the drill pipe to form an interference fit therebetween. Each stripper seal may be flexible enough to accommodate and seal against threaded couplings of the drill pipe having a larger tool joint diameter. The drill pipe may be received through a bore of the bearing assembly so that the stripper seals may engage the drill pipe. The stripper seals may isolate the riser 25r from the UMRP 20 both when the drill pipe is stationary and rotating.

The catch sleeve may have a landing shoulder formed at an outer surface thereof, a catch profile formed in an outer surface thereof, and may carry one or more seals on an outer surface thereof. Engagement of the latch dogs with the catch sleeve may connect the bearing assembly to the docking station. The bearing pack may support the strippers from the catch sleeve such that the strippers may rotate relative to the docking station. The bearing pack may include one or more radial bearings, one or more thrust bearings, and a self contained lubricant system. The bearing pack may be disposed between the strippers and be housed in and connected to the catch sleeve, such as by a threaded couplings and/or fasteners.

The fluid handling system 601h may include the mud pump 24, the shale shaker 26, the pressure sensor 27p, the stroke counter 27c, the tank 28, the feed line 29f, a reverse supply line 629s and a reverse return line 629r. A lower end of the reverse supply line 629s may be connected to the (inlet) fluid port of the RCD 621 and an upper end of the reverse supply line may be connected to the mud pump outlet. An upper end of the reverse return line 629r may be connected to the swivel outlet and a lower end of the reverse return line may be connected to the shaker inlet.

In the reverse drilling mode, the mud pump 24 may pump the drilling fluid 22f from the feed line 29f, through the pump outlet and supply line 629s to the RCD 621. The drilling fluid 22f may flow down the riser annulus, through the PCA and wellhead annuli, and into the wellbore annulus 39a, where the fluid may circulate the cuttings into the bit 615. The returns 22r may flow through the BHA 610b, thereby powering the motor 612 to rotate 21b the bit 615. The returns 22r may continue from the BHA 610b, through the conveyor string 10p, and to the bypass swivel 605. The returns 22r may be diverted by the closed Kelly valve 606 into the return line 629r. The returns 22r may continue through the return line to the shale shaker 33 and be processed thereby to remove the cuttings, thereby completing a cycle. As the drilling fluid 22d and returns 22r circulate, the drill bit 615b may be rotated 21b by the motor 612 and/or top drive 5 and lowered by the traveling block 6, thereby extending the wellbore 39b into the lower formation.

Alternatively, the drilling system 601 may be convertible between the reverse circulation drilling mode and a forward circulation drilling mode.

While the foregoing is directed to embodiments of the present disclosure, other and further embodiments of the disclosure may be devised without departing from the basic scope thereof, and the scope of the invention is determined by the claims that follow.

1. A tachometer for a downhole motor, comprising:
a tubular housing having a coupling for connection to a housing of the motor;
a probe: having a coupling for connection to a rotor of the motor, movable relative to the tachometer housing, and having at least a portion disposed in a bore of the tachometer housing;
electronics disposed in the tachometer housing and comprising:
a battery;
one or more proximity sensors for tracking an orbit of the probe; and
a programmable logic controller (PLC) operable:
to receive the tracked orbit, and
at least one of:
to determine an angular speed of the probe using the tracked orbit, and
to forecast a remaining lifespan of the motor using the tracked orbit.

2. The tachometer of claim 1, wherein the PLC is operable to determine the angular speed of the probe using the tracked orbit.

3. The tachometer of claim 1, wherein the PLC is operable to forecast the remaining lifespan of the PC motor using the tracked orbit.

4. The tachometer of claim 3, further comprising an accelerometer disposed on the probe for measuring the angular speed.

5. The tachometer of claim 1, further comprising a solid state drive for recording the tracked orbit.

6. The tachometer of claim 1, further comprising a target array disposed on the probe, wherein the proximity sensors are Hall effect sensors.

7. The tachometer of claim 1, wherein:
the probe has one or more lobes formed in an outer surface thereof,
the electronics further comprise a base,
the proximity sensor is disposed on the base, and
the base has two or more lobes formed in an inner surface thereof.

8. The tachometer of claim 7, further comprising:
a target array disposed on the probe and having a number of targets corresponding to a number of the probe lobes,
wherein a number of proximity sensors corresponds to a number of the base lobes.

9. The tachometer of claim 1, further comprising:
a first pressure sensor in fluid communication with an exterior of the housing; and
a second pressure sensor in fluid communication with a bore of the housing,
wherein the PLC is further operable to estimate torque output by the PCM using the pressure measurements.

10. A progressive cavity motor (PCM), comprising:
a rotor having one or more helical lobes formed in an outer surface thereof;
a stator having two or more helical lobes formed in an inner surface thereof; and
the tachometer of claim 1, wherein:
the probe is connected to a top of the rotor, and
the housing is connected to a housing of the stator.

11. The PCM of claim 10, further comprising an auxiliary probe connected to a bottom of the rotor and comprising at least of:
a strain gage for measuring torque of the rotor, and
a pressure sensor for measuring discharge pressure of the motor.

12. A bottomhole assembly (BHA), comprising:
the PCM of claim 11; and
a solid state flowmeter.

13. A method of drilling a wellbore, comprising:
drilling the wellbore by injecting drilling fluid through a drill string extending into the wellbore from a drilling rig and rotating a drill bit disposed on a bottom of the drill string, wherein:
the drill string comprises a downhole drilling motor, and
the motor rotates the drill bit; and
while drilling the wellbore and in real time:
tracking an orbit of a rotor of the motor; and
at least one of:
determining an angular speed of the rotor using the tracked orbit, and
forecasting a remaining lifespan of the motor using the tracked orbit.

14. The method of claim 13, wherein the angular speed is determined using the tracked orbit.

15. The method of claim 13, wherein the remaining lifespan is forecasted using the tracked orbit.

16. The method of claim 15, wherein the remaining lifespan is forecasted by monitoring stalls of the motor using the tracked orbit.

17. The method of claim 15, wherein the remaining lifespan is forecasted by monitoring eccentricity of the tracked orbit

18. The method of claim 13, further comprising transmitting the angular speed and/or forecast lifespan to the drilling rig while drilling the wellbore.

19. The method of claim 13, further comprising recording the tracked orbit while drilling the wellbore.

20. The method of claim 13, further comprising, while drilling the wellbore and in real time:
measuring an inlet pressure of the motor and an annulus pressure adjacent the motor; and
estimating torque output by the motor using the pressure measurements.

21. A method of drilling a wellbore, comprising:
drilling the wellbore by injecting drilling fluid through an annulus formed between the wellbore and a drill string extending into the wellbore from a drilling rig and rotating a drill bit disposed on a bottom of the drill string, wherein:
the drill string comprises a downhole drilling motor, and
the motor rotates the drill bit; and
while drilling the wellbore and in real time:
tracking an orbit of a rotor of the motor; and
at least one of:
determining an angular speed of the rotor using the tracked orbit, and
forecasting a remaining lifespan of the motor using the tracked orbit.
